(19) United States
(12) Patent Application Publication
(10) Pub. No.: US 2019/0378174 A1
(43) Pub. Date: Dec. 12, 2019

(54) DIGITAL MALL AND SOCIAL MEDIA PLATFORM

(71) Applicants: Peter P. BURR, Cazenovia, NY (US); Steven C. PETROCELLI, Sayville, NY (US)

(72) Inventors: Peter P. BURR, Cazenovia, NY (US); Steven C. PETROCELLI, Sayville, NY (US)

(21) Appl. No.: 16/411,550

(22) Filed: May 14, 2019

Related U.S. Application Data
(60) Provisional application No. 62/681,753, filed on Jun. 7, 2018.

(51) Int. Cl. G06Q 30/02; G06F 16/958; G06Q 50/00

(52) U.S. Cl. CPC G06Q 30/0271; G06Q 50/01; G06F 16/958

(57) ABSTRACT

A method and system for providing a digital platform hosted on a computer, where the digital platform provides commercial products and social media interaction accessible by a user using a device. In response to receiving a selection by a user of a first advertisement depicted on a display of a device, a first advertisement is opened using an application. The opening of the first advertisement is opened as a first portal within a digital platform for the plurality of advertisements, and each of the advertisements accessing content data for each of the advertisements within the digital platform. A first plurality of interactive elements of the first advertisement is displayed, in response to the user selecting the first advertisement. The interactive elements are associated with the first advertisement, and the interactive elements are in the first portal within the digital platform for the first advertisement.

### CROSS-REFERENCE TO RELATED APPLICATION

This application claims priority under 35 U.S.C. § 119(e) of U.S. Provisional Patent Application Ser. No. 62/681,753, filed Jun. 7, 2018, the disclosure of which is hereby incorporated by reference in its entirety.

### BACKGROUND

The present disclosure relates to a method and system for providing a digital shopping and buying experience for users employing a digital mall platform and a social media platform. The method and system uses a computer and computer programs which enable shopping and social media posting for a user using a device or a computer.

Currently, electronic social media networks can interconnect many users via their devices to a social media platform using a communications network, which can include the Internet. Additionally, digital store fronts are able to offer products for viewing and purchasing, and may provide a comments or review section.

### SUMMARY

A problem with social media networks and techniques is that companies or brands are not able to effectively advertise, and initiate and encourage discussions about their products/company/brand. Additionally, current social media platforms tack on advertisements and product suggestions, as well as purchasing information, to the display area dominated by social media interaction regarding buying or store platforms, they typically provide a comments section, or review section, without true social interaction as in a social media platform. Both known approaches are cumbersome and lack efficiency, that is, regarding purchasing for the social media platform, and regarding social interaction in the buying or store platform. These techniques of advertising are undesirable because they are frequently skipped over and ignored by the user on a social media platform and interfere with navigation by the user. For purchasing or store front platforms, the reviews or comments are often difficult to find, or require scrolling through pages to find. Further, another disadvantage of current techniques and systems is advertisers may not be effectively spending advertising money when advertisements are ignored or skipped by users on the social media platform, and sellers are not receiving important feedback from customers on their store platforms. The typical buying or store platforms do not allow for true social media interaction as the social media platforms.

It would therefore be advantageous to provide a purchasing and social experience combination as interaction with a website and social media platform. It would also be desirable to provide a more effective technique for advertising a product on social media and to more effectively reach users regarding a product. Further, it would also be desirable to provide a more effective technique for social interaction, commenting, and posting when purchasing a product on a platform, as well as viewing and shopping for products.

The system and method according to the present disclosure provides a social media/e-commerce platform, embodied as a digital mall platform, which allows for an efficient and direct consumer accessible marketing mechanism for users to engage in a user friendly social network, and for companies/brands to promote and advertise their products and services. The social/media digital platform or digital mall platform can provide content of commercial media for products, sports events, concerts, etc. An advantage of the social media platform of the present disclosure is providing a medium for advertisement of products in an entertaining form where a user or consumers can circulate, discuss, comment, and post about, the content through a social network.

In one aspect according to the present invention a method for providing a digital platform hosted on a computer, is provided where the digital platform provides commercial products and social media interaction accessible by a user using a device. The method includes receiving, using a computer system, a plurality of advertisements for posting on a digital platform, and receiving content data, using the computer system, for each of the plurality of advertisements. The method includes posting, using the computer system, the plurality of advertisements on the digital platform, and the digital platform is viewable on a display of a device. Each of the advertisements having a section of the viewable area in a contiguous relationship to each other in the viewable area on the display of the device, and the digital platform is hosted on the device using an application on the device and is in communication, using a communications network, with a content server which hosts the content data for each of the plurality of advertisements. The digital platform is accessible by a plurality of users via the application on computer devices, respectively, for each of the plurality of users. The method includes configuring and enabling each advertisement as a portal within the digital platform for each of the respective advertisements. The advertisements are selectable and link to the content data for a respective advertisement as a portal, respectively, when the advertisement is selected by one of the plurality of users on their device, and the content data is hosted on the computer system of the digital platform. The method includes accessing a first portal, in response to receiving a selection of a first advertisement by a user, where the first portal is respective to the first advertisement selected by the user, and the first portal is associated with first content data, for the first advertisement, stored on the computer system of the digital platform. The method includes displaying the first content data for the first advertisement selected within the first portal, respective to the advertisement, on the digital platform.

In another aspect according to the present invention, a method for providing a digital platform hosted on a computer is provided. The digital platform provides commercial products and social media interaction accessible by a user using a device. The method includes: opening a first advertisement, in response to receiving a selection by a user, using an application, of the first advertisement depicted on a display of a device, the first advertisement being in a first section of a viewable area of the display of the device, the viewable area having a plurality of advertisements each having a section of the viewable area in a contiguous relationship to each other in the viewable area on the display of the device, the opening of the first advertisement being opened as a first portal within a digital platform for the plurality of advertisements, and each of the advertisements accessing content data for each of the advertisements within the digital platform, the content data being hosted on a content server of the digital platform, and the application on the device communicating with the digital platform; displaying a first plurality of interactive elements of the first advertisement, in response to the user selecting the first advertisement, the interactive elements being associated with the first advertisement, and the interactive elements being in the first portal within the digital platform as part of first content data for the first advertisement, and; displaying and providing featured options, as part of the first content data for the first advertisement for interaction related to the first advertisement, in response to the user selecting one or more of the first plurality of interactive elements, respectively.

In another aspect according to the present invention, a system for providing a digital platform hosted on a computer is provided. The digital platform providing commercial products and social media interaction accessible by a user using a device, where the system comprises a computer system comprising: a computer processor, a computer-readable storage medium, and program instructions stored on the computer-readable storage medium being executable by the processor, to cause the computer system to perform a method to receive, using a computer system, a plurality of advertisements for posting on a digital platform; and receive content data, using the computer system, for each of the plurality of advertisements. The method continues to post, using the computer system, the plurality of advertisements on the digital platform, the digital platform is viewable on a display of a device and, each of the advertisements has a section of the viewable area in a contiguous relationship to each other in the viewable area on the display of the device. The digital platform is hosted on the device using an application on the device and is in communication, using a communications network, with a content server which hosts the content data for each of the plurality of advertisements. The digital platform is accessible by a plurality of users via the application on computer devices, respectively, for each of the plurality of users. The method continues to configure and enable each advertisement as a portal within the digital platform for each of the respective advertisements. The advertisements are selectable and link to the content data for a respective advertisement as a portal, respectively, when the advertisement is selected by one of the plurality of users on their device, and the content data is hosted on the computer system of the digital platform. The method continues to access a first portal, in response to receiving a selection of a first advertisement by a user, and the first portal is respective to the first advertisement selected by the user, and the first portal being associated with first content data, for the first advertisement, and stored on the computer system of the digital platform. The method continues to display the first content data for the first advertisement selected within the first portal, respective to the advertisement, on the digital platform.

In another aspect according to the present invention, a system for providing a digital platform hosted on a computer is provided, and the digital platform provides commercial and social media and products accessible by a user using a device, the system comprising: a computer system comprising: a computer processor, a computer-readable storage medium, and program instructions stored on the computer-readable storage medium being executable by the processor, to cause the computer system to perform a method, to: open a first advertisement, in response to receiving a selection by a user, using an application, of the first advertisement depicted on a display of a device, and the first advertisement is in a first section of a viewable area of the display of the device, and the viewable area having a plurality of advertisements each having a section of the viewable area in a contiguous relationship to each other in the viewable area on the display of the device, and the opening of the first advertisement being opened as a first portal within a digital platform for the plurality of advertisements, and each of the advertisements accessing content data for each of the advertisements within the digital platform, the content data being hosted on a content server of the digital platform, and the application on the device communicating with the digital platform; display a first plurality of interactive elements of the first advertisement, in response to the user selecting the first advertisement, and the interactive elements are associated with the first advertisement, and the interactive elements being in the first portal within the digital platform as part of first content data for the first advertisement; and display and provide featured options, as part of the first content data for the first advertisement for interaction related to the first advertisement, in response to the user selecting one or more of the first plurality of interactive elements, respectively.

In another aspect according to the present invention, a computer program product for providing a digital platform hosted on a computer is provided, and the digital platform provides commercial products and social media interaction accessible by a user using a device. The computer program product comprises a non-transitory computer readable storage medium having program instructions embodied therewith, and the program instructions executable by a computer to cause the computer to perform a method, comprising: opening a first advertisement, in response to receiving a selection by a user, using an application, of the first advertisement depicted on a display of a device, the first advertisement being in a first section of a viewable area of the display of the device, the viewable area having a plurality of advertisements each having a section of the viewable area in a contiguous relationship to each other in the viewable area on the display of the device, the opening of the first advertisement being opened as a first portal within a digital platform for the plurality of advertisements, and each of the advertisements accessing content data for each of the advertisements within the digital platform, the content data being hosted on a content server of the digital platform, and the application on the device communicating with the digital platform; displaying a first plurality of interactive elements of the first advertisement, in response to the user selecting the first advertisement, the interactive elements being associated with the first advertisement, and the interactive elements being in the first portal within the digital platform as part of first content data for the first advertisement; and displaying and providing featured options, as part of the first content data for the first advertisement for interaction related to the first advertisement, in response to the user selecting one or more of the first plurality of interactive elements, respectively.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawing are discussed forthwith below.

FIG. 1 is a schematic block diagram illustrating an overview of a system and methodology for providing a digital platform embodied as a digital mall platform, according to an embodiment of the disclosure.

FIG. 2 is a flow chart illustrating a method, implemented using the system shown in FIG. 1, for providing a digital mall platform, according to an embodiment of the disclosure.

FIG. 3 is a flow chart illustrating another method, following from the method shown in FIG. 2, and implemented using the system shown in FIG. 1, for providing a digital mall platform, according to an embodiment of the disclosure.

FIG. 4 is a functional block diagram depicting an embodiment of the digital mall platform based on FIGS. 1, 2 and 3.

FIG. 5 is a functional block diagram depicting an embodiment of the digital mall platform related to FIGS. 1, 2 and 3.

FIG. 6 is a functional and instructional block diagram illustrating an embodiment of the digital mall platform and which is related to the embodiments shown in FIGS. 1-5.

FIG. 7 is a schematic block diagram depicting a computer system according to an embodiment of the disclosure which may be incorporated, all or in part, in one or more computers shown in FIG. 1, and cooperates with the system and methods shown in FIGS. 1, 2, 3, 4, 5 and 6.

FIG. 8 is a schematic block diagram of a system depicting system components for use and communicating using a bus. The system components being usable, all or in part, with the embodiments of the present disclosure, in accordance with one embodiment of the present disclosure.

FIG. 9 is a functional block diagram depicting a cloud computing environment according to an embodiment of the present invention.

FIG. 10 is a functional block diagram depicting abstraction layers for the cloud computing environment of FIG. 9 and according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

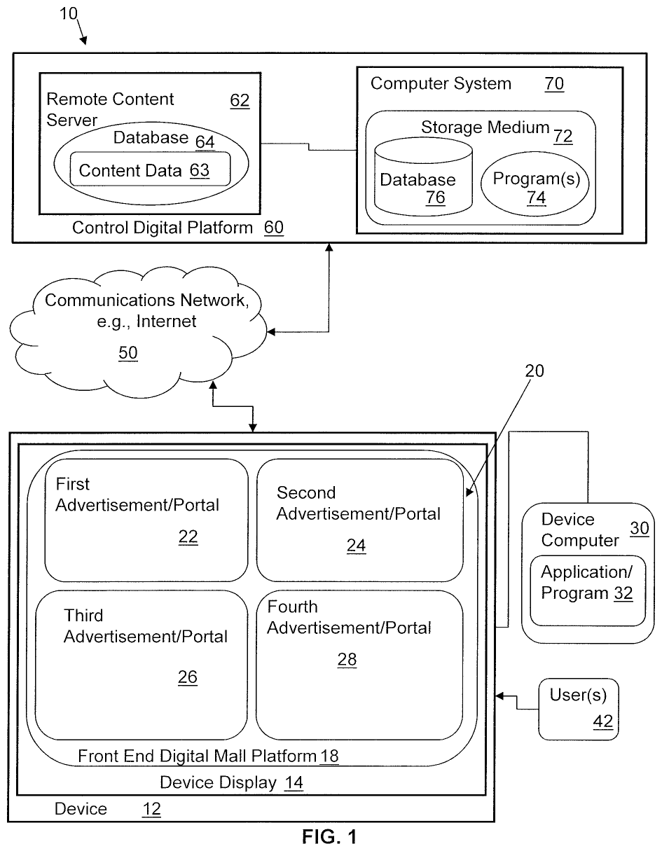

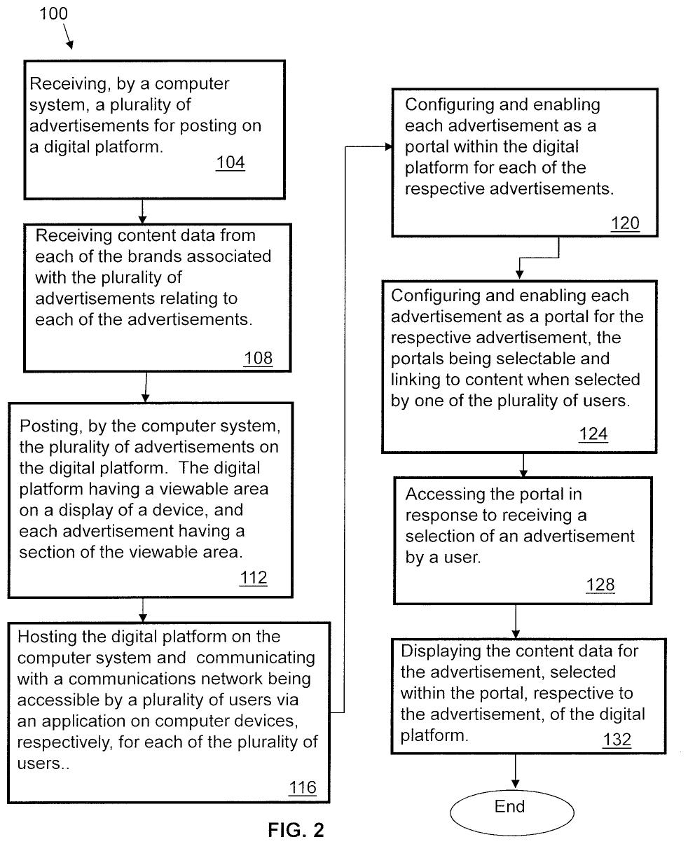

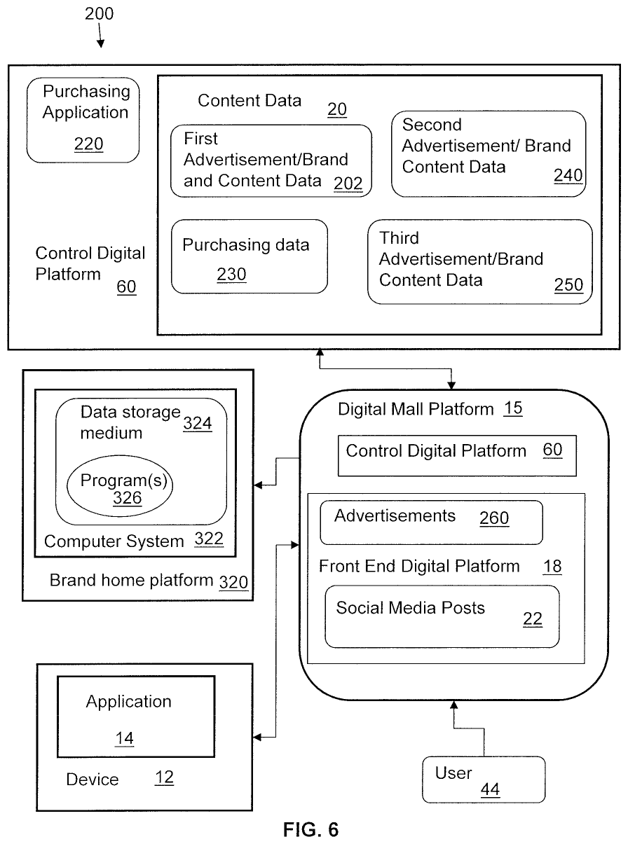

Referring to FIGS. 1 and 2, a method 100 (FIG. 2) with reference to a system 10 (FIG. 1) according to an embodiment of the present disclosure is provided for providing a digital platform enabling a digital mall platform. The digital mall platform 15 (see FIG. 6) encompasses a front-end digital platform 18 or front-end part of the digital mall platform, and a control digital platform 60 or back end part of the digital mall platform 15. The front-end digital platform 18 can be downloaded as an application on a device. It is understood that the digital mall platform is referring to herein at both the front-end digital platform 18 and the control digital platform 60, which collectively comprise the digital mall platform 15 (shown in FIG. 6). Embodiments of the present disclosure may be implemented as a method using one more programs, or software applications, and other embodiments of the present disclosure can be implemented as one or more systems, and/or one or more computer program products, locally, remotely on a remote server, as a cloud based application, or as a service. Such implementation will be discussed in more detail herein with reference to the drawings. The computer implemented method 100 provides a digital platform having social media, and commercial media and products accessible by a user using a device.

The method 100 includes, receiving, by a computer system 70 of the control digital platform 60, a plurality of advertisements for posting on a digital platform 18, at block 104. Each of the advertisements are for products of a brand or company selling the respective products or services. It is understood that herein the advertiser is referred to as the brand or the company selling. The digital platform is generated by an application or program 32 (e.g., at the front-end of the platform) on a device computer 30 communicating with programs 74 on a storage medium 72 (e.g., at a back-end of the platform) to present the digital platform on a device display 14 of a device 12 used by a user 42.

It is understood that the digital platform can be generated from the application 32 and the application 32 can communicate with a remote computer system 40 and/or a server 60 which communicate with the device and application 32 using a communications network 50, such as the Internet. As shown in FIG. 1, multiple advertisements are posted on a device display 14, including a first advertisement/portal 22, a second advertisement/portal 24, a third advertisement/portal 26, and a fourth advertisement/portal 28. The advertisements can be collectively referred to as advertisements 260 (see FIG. 6). The depicted advertisements are representative of posted advertisements which can be a subset of the plurality of advertisements received by the computer system 70 and stored, in whole or in part, by the computer system 70 and/or the device computer 30 using the application 32. Such plurality of advertisements can be scrolled through by a user using the device display. The advertisements shown in FIG. 1 are representative of advertisements for display and illustrative of the plurality of advertisements.

The digital platform can be generated and delivered by the application 32 in one embodiment, by the computer system 70 in another embodiment, or a combination of the device computer 30 and the computer system 70 by using the application 32 in another embodiment. In one example, the digital platform includes a front-end computer 30 and a back-end computer 70 which can communicate with a remote server(s) 62 and database(s) 64, or in another embodiment the application can use cloud based delivery and services, or can use one or more remote servers. It is understood that other combinations of technical operation and delivery are also possible, and the embodiments described herein are not intended to exclude other means.

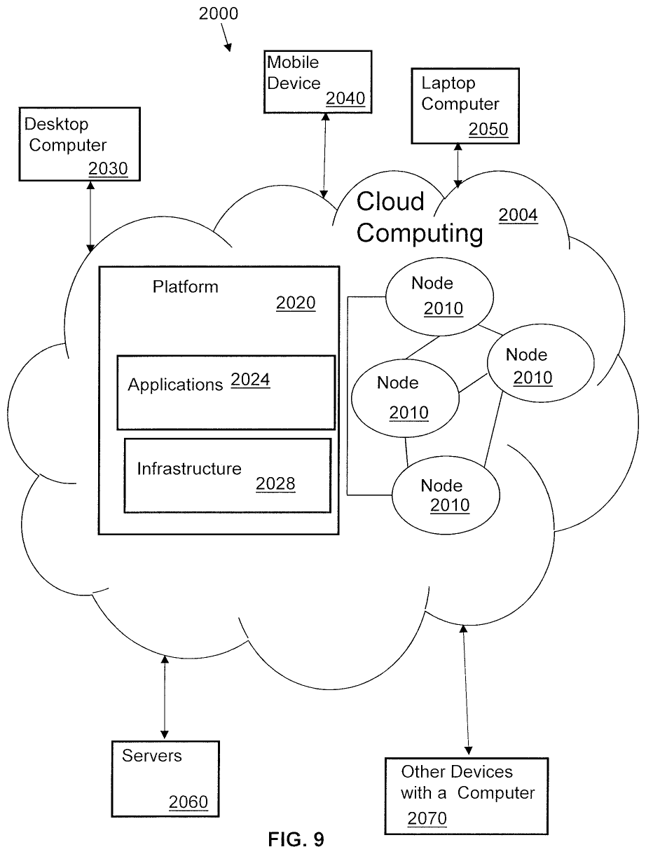

In general, the computer can include a database, for example, locally connected, and alternatively, communicating remotely with the computer, for storing the data in accordance with the method and system of the present disclosure, and communicating with the application 32 using the communications network 50. Thus, the front-end application 32 can communicate with the back-end program(s) 74 as necessary and required, for example, for any information, data not stored or accessible at the application 32 and device computer 30. In an alternative, the program(s) 74 can be part of a remote server 62 communicating, using a communication network 50, for example, the Internet. The remote server 62 may include a database 64 for storing data. In another alternative, the program(s) can be stored in a cloud environment (described in more detail in relation to FIGS. 8-9) and communicate with the application 32 similarly as described above. In the presently described embodiment shown in FIGS. 1 and 2, the method and system of the present disclosure is generically shown and described as being an application 32 stored on a device 12 having a computer 30, which communicates with other components of the system 10, such as back end program(s) 74 stored in the computer system 70.

The plurality of advertisements 20 are represented collectively by the first advertisement/portal 22, second 24, third 26, and the fourth advertisement/portal 28. It is understood that any of the first advertisement/portal through the fourth advertisement/portal may be referred to as an advertisement or a portal herein and are representative of possibly many more advertisements/brands that make up the plurality of advertisers. The number of advertisements/portals displayed on a device display can vary depending on the size of the device screen, size of the advertisement/portal, or size of the section of the screen designated for the advertisement/portal.

The method 100, can be embodied in a computer program or application, and as a series of programs or group of programs, or a suite of software. In general, in one embodiment, a computer program or application 32 can be installed on a device 12. The application 32 is configured to provide the digital mall platform 18 on the device 12 for a user 44. The application 32 can also interact (in cooperation with and/or conjunction with) with a program or programs 74 stored on a storage medium 72 on a computer system 70, remote from the application 32, or on a remote content server 62, for delivering to the device 12 the digital mall platform 18. The digital mall platform 18 includes presenting or displaying the plurality of advertisements 20 on a device display. The advertisements are also referred to as the advertisement portals, or portals 22, 24, 26, 28.

The digital mall platform or digital platform includes the application or application software, for use on a device. The application can be self-contained or a group of programs (e.g., software program or group of programs). The application is directed to perform functions for display and use by an end user, viewing and/or interacting with the application using a screen or monitor of a device.

The digital mall platform can interact with computer systems, and server(s), whether local, remote, or cloud based, to store and execute, in all or part, the programs associated with the application, whether considered back-end or front-end of the system and method of the digital platform.

The digital platform 15 includes a computer 70 having a database 64 and one or more programs 74, incorporated as a control digital platform 60. In the embodiment of the disclosure shown in FIG. 1, the application 32, implementing the front-end digital mall platform 18, communicates with the control system 60 and the one or more programs 74. The control system 60 includes the computer 70 which also has access to the database 64. The control system 60 includes the storage medium 72 for maintaining a registration of brands or companies which are compatible for collaboration. In an embodiment, the control system 60 works in combination and in cooperation with the front end of the application, which is stored on the device and which application can access data and additional programs at the back end of the platform, that is, the control digital platform 60.

The digital mall platform receives content data from a plurality of brands with respect to each of the plurality of advertisements, as in block 108 of the flowchart shown in FIG. 2. It is understood, for example, a brand refers to a retailer or service provider. The content data refers to the brands products or services. The digital mall platform receives content data from the plurality of brands, in response to a brand, using an administrative application, uploading selected content related to their brand to the digital mall platform 18. The content data 63 can be stored in a database 64 on a remote content server 62 of the control digital platform 60. The content data is initiated and uploaded by the brand, and/or with the respective company's or brand's consent, imported as content data for the respective brand on the digital mall's control digital platform 60. The content data can include all or part of website content of the brand and can include other content data. Such website content of the brand is understood to be the brand's or company's. The content data can include advertisements and purchasing and buying techniques for a user which are operable from the digital mall platform. The mall application 32 interacts with the control digital platform 60, including the front end digital platform 18 and the control digital platform 60, by providing a brand's digital content to a user via the user's device 12, e.g., displayed on the device's screen or display 14 for interaction by the user. The digital mall platform 15, using the application 32, enables interaction with a user so the user can select, order, and complete buying transaction from the brand as a portal within the application using the front-end digital mall platform 18. The brand content data becomes part of the digital mall platform as a portal or brand portal, respective to the each of the brands.

In one example, each brand advertisement/portal displayed via the application of the digital mall platform can receive input initiated from the user, or in other words, a user initiated interaction received by the application, e.g., selection of an item, order, purchasing an item, selection of a link, etc. In the embodiments of the present disclosure, the user initiated interaction is completed for example, an order, or selection of another link, within the portal of the digital mall platform. This is in contrast to electronically directing a user to a website outside of the portal, for example, the external website of the brand, when the user initiates an interaction in an advertisement. In the embodiments of the present invention, actions within the advertisement or portal, initiated by the user, are processed within the portal.

It is envisioned that the brands will maintain their own websites, outside the portal and the digital mall, maintains its own platform, respectively. Such brand platforms are represented in FIG. 6 as brand home platform 320 having a computer system 322. The computer system 322 having data storage medium 324 which can store a program(s) 326. In one example, the brand website and platform are selectable via a link within the digital mall platform if a user wants to open the brand website.

As described above, the portal is part of the digital mall platform. The portal is not a website outside the digital mall platform. The referred to brand or company website exists in addition to, and outside, the digital mall platform. The digital mall platform provides a social ecommerce application. The digital mall platform can include server, cloud based resources such as servers, hardware and interfaces for enabling the application.

Referring to FIG. 1, as discussed above, the method 100 receives, by the computer 70 of the control platform 60, the plurality of advertisements for posting on the digital mall platform 18, at block 104. The method 100 includes receiving content data from each of the brands associated with the plurality of advertisements relating to each of the advertisements, as in block 108. The method 100 includes posting, by the control platform 60, the plurality of advertisements 20 on the digital platform 18. The digital platform has a viewable area on the display 14 of the device 12, as in block 112. Each advertisement 22, 24, 26, 28 has a section of the viewable area of the device display 14. The digital platform 18 is hosted by the computer system 70 of the control platform 60 and the device computer 30, and communicates with a communications network 50. The digital mall platform 18 is accessible by a plurality of users represented by user(s) 42 via the application(s) 32 on the computer 30, as in block 116. It is understood the user 42 and the device 12 and device computer 30 represents an example of a plurality of users and devices accessing the digital platform 18 on their respective devices, in which the plurality of devices communicate with the control platform 60 via the communications network 50.

The method 100 includes configuring and enabling each advertisement as a portal within the digital platform for each of the respective advertisements, as in block 120. The portals include (for example, portals 22, 24, 26 and 28) for the respective advertisements. The advertisements are selectable and link to the content data for a respective advertisement as a portal, respectively, when the advertisement is selected by one of the plurality of users on their device.

The method includes configuring and enabling each advertisement as a portal within the digital platform for each of the respective advertisements, the advertisements being selectable and linking to the content data for a respective advertisement as a portal, respectively, when the advertisement is selected by one of the plurality of users on their device, as in block 124.

The method includes accessing a portal, in response to receiving a selection of an advertisement by a user, the portal accessed being respective to the advertisement selected by the user, as in block 128.

The method includes displaying the content data for the advertisement selected within the portal, respective to the advertisement, of the digital platform, as in block 132.

In one embodiment, the method can include defining a viewable area of the device display into sections, such that the advertisements are positioned in portions of the device display in designated sections, and nothing else is posted on the display. In other words, the plurality of advertisements use the whole display viewable area and nothing else is displayed in the viewable area.

In another embodiment according to the present disclosure, a method 150 proceeds from block 132 of the method 100 (FIG. 2). The method 150 includes displaying a first plurality of interactive elements, in response to the user selecting the first advertisement, as in block 154. The interactive elements are associated with the first advertisement such that the first advertisement is a first portal interactively allowing access to the first plurality of interactive elements.

The method 150 includes displaying and providing featured options for interaction related to the first advertisement, in response to the user selecting each of the first plurality of interactive elements, as in block 158.

The method 150 further includes opening a dialog box for the user to interact with the advertisement, in response to a user selecting an interactive element, as in block 162. Receiving interaction in the dialog box by the user which allows the user to interact with other user, for example, by one or more of: commenting on the commercial post, sharing the commercial post, reposting, directing to a feature page of the advertisement or another post, including posting any comment, recommendations, reviews, or other such remark, statement, or observation, as in block 166.

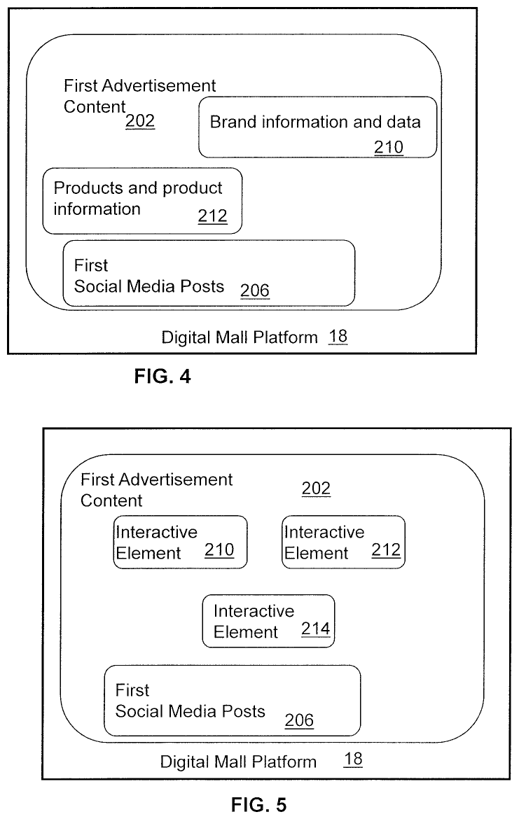

In describing the methods 100 and 150, and system 10 of the present disclosure, reference is also made to functional or operational schematic block diagrams in FIGS. 4 and 5.

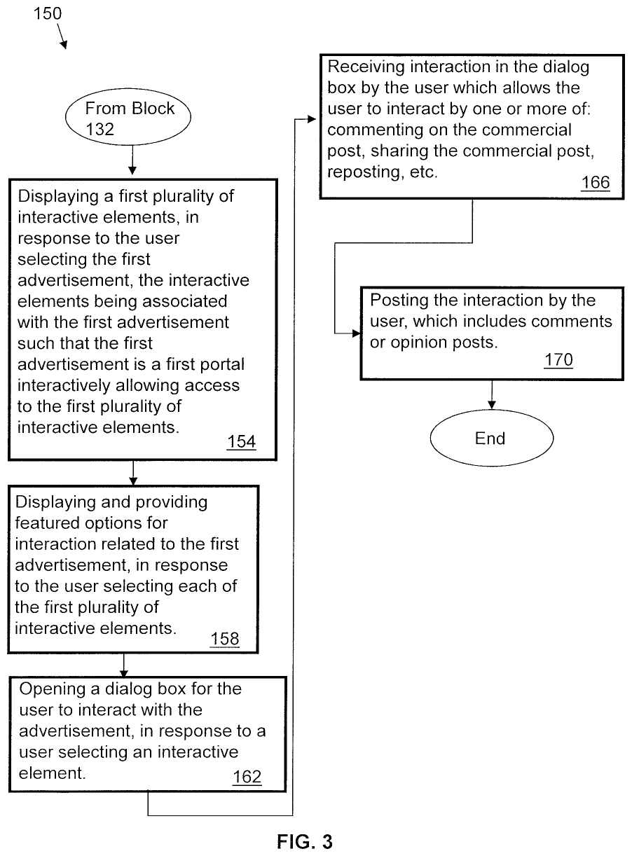

Referring to FIGS. 4, 5 and 6 in conjunction with FIGS. 1, 2 and 3, the first advertisement content 202 is displayed on the device display 14 as part of the digital mall platform 18, in response to the user selecting the first advertisement in a first section of the device display 14, as in block 132. It is understood that FIGS. 3 and 4 show the first advertisement content as an example, and representative of other advertisement content. The first advertisement content can include, for example, ads, interactive elements, data about products. An example of such plurality of advertisements/brands is shown as second advertisement/portal 24 including second advertisement/brand content data 240 (FIG. 6), and third advertisement/portal 26 including third advertisement/bran content data 250, and so on for the fourth advertisement/brand and more.

Within the digital mall platform 18 is an area or dialog box for social media posts. The first advertisement content 202 can be an ad initiated by selection of the first advertisement/portal 22 and displayed as part of the first portal. A first social media posts 206 is part of the digital mall platform for the first advertisement content Thereby, when a user selects the first advertisement/portal 22, the portal is entered and provides the first advertisement content 202, which includes a dialog box or area for first social media posts 206, as well as other options which are selectable, such as interactive elements 210, 212, 214.

Referring to FIG. 4 in conjunction with FIGS. 1, 2 and 3, the method includes displaying a first plurality of interactive elements 210, 212, 214, in response to the user selecting the first advertisement, as in block 124. The interactive elements are associated with the first advertisement such that the first advertisement is a first portal interactively allowing access to the first plurality of interactive elements 210.212.214.

The method includes displaying and providing featured options for interaction related to the first advertisement/portal 22, in response to the user selecting each of the first plurality of interactive elements, 210, 212, 214, as in block 124. Thereby, the first advertisement/portal 22 provides a portal to the advertisement, and interactive elements 210, 212, and 214. The interactive element can each direct or link to another aspect of the advertisement, a buying or purchasing option, an entertainment option, a chat or social option for posting comments, opinions or chatting with other users. In one example, a chat box can be used to type text communications with other users, and receive responses from the other users. Such communications can include comments and opinion on products or services advertised or shown.

In another example, a purchasing option can communicate with a purchasing application 220 communicating with purchasing data 230 stored on the control digital platform 60. The purchasing application 220 can enable purchasing function and techniques for a user while using the digital platform, and the purchasing data 230 can include an account or profile, purchasing history, and purchasing information.

In another example, in response to a user selecting an interactive element, a dialog box can be opened for the user to interact with the advertisement. The dialog box allows the user to interact with other users. The interaction can be, for example, by one or more of: commenting on an advertisement or service, commenting on a commercial post, sharing the commercial post, reposting, directing another user to a feature page of an advertisement or another post.

Posting social content, for example in a dialog box, can include comments, observations, or reviews regarding the advertisement, brand, or item, as in block 170.

For example, according to the embodiments of the present disclosure, interactive element 210 can lead or link to a video, and interactive element 212 can lead or link to a product and a buying option. It is understood that one or more interactive elements (for example, interactive element 210) can lead to (or link to) an entertainment display (such as a video), which then has an interactive element (for example after a video has finish, an interactive element can display) that leads or links to a options (such as a product or a website), which in turn has an element that leads to a purchase function for purchasing a product, and still further, then displays an element that leads to links to a chat option (which can include a chat room, or dialog box for chatting with comments, likes, emojis, etc.). Thus, each advertisement/portal, functions as a portal, for example, as a portal for brand and product information, purchasing and social interaction for a user, without leaving the digital mall platform 18.

Referring to embodiment of the present disclosure, advertisements for products, concerts, videogames, sports, fashion trends, etc., can be the content of the digital mall platform (which in includes, for example, a social media platform). Application profiles can reflect a company's individual ecommerce websites, and serve as a “storefront”. One advantage of the present disclosure is that the digital mall platform provides company or brand advertisement on one platform connected by a social network and a virtual space to advertise and promote featured products or services, in addition to providing a platform for electronic social interaction.

The digital mall platform gives a digital outlet and presence to business (for example, brick and mortar stores at a mall) to display their products virtually in an all on one platform. In the digital mall platform, advertisements are directly accessible through e-commerce and social media portals with social profiles as the company's storefront or new ecommerce website. The digital mall platform eliminates third party ecommerce websites that companies use to sell and promote their product lines, and the digital mall platform connects companies to a social network.

Embodiments according to the present disclosure enable a social aspect of brick and mortar stores as in a mall by enabling company advertisements and products to be shared, discussed, rated, or purchased, on a digital mall platform. The products can be subject to viewer reviews, support from customers, or other comments. Embodiments of the present disclosure provide that the digital mall platform allows for a direct interaction between commercial media and consumers.

Embodiment of the present disclosure provide a digital mall platform for receiving advertisements, posting them on an entire page using an application and on a display of a device (for example, a full page of a display, or full page of an application) (and not as an accessory on a social network, e.g., to the side of a webpage, or on the bottom or top of a webpage, etc.). A selection for interaction is on the advertisement's section of the displayed page.

The present method and system is advantageous over present social media platforms because the digital mall platform provides a means to provide advertisements coupled with social interaction, without tacking on advertisements and purchase options to a social media platform, or tacking on a comments section to a buying application or digital storefront.

Embodiments of the present disclosure can include content of the digital mall platform focusing on current trends, concerts, sports, fashion, videogames, technology, cars, etc., from a newsfeed where the content will be displayed to a user. This can be referred to as a worldfeed for posting all types of posts. A user, for example, can watch an advertisement, and can forward the advertisement, comment, indicate that the user likes the post, re-post the advertisement with a comment, or the user, in one example, can select a link to go to a company's or brand's featured product within the digital mall platform. Within the digital mall platform, the user can buy a product and/or view all the content of the brand or company. In another example, the user can select a link to go to the company's or brand's website outside the digital mall platform.

Embodiments of the present disclosure enable advertisements to be directly accessible through e-commerce and social media portals with profiles as a company store front or new ecommerce website. The present disclosure provides a means to sell and promote product lines and connect users on a social network in one digital platform.

Through the digital mall platform, company advertisements and products can be shared, discussed, rated, or purchased. They can be subject to viewer criticism, support, or other comments, and user reactions. This allows for a direct interaction between commercial media and consumers. Surveying to gauge consumer satisfaction will be eliminated through the direct social medium of the digital mall platform. The digital platform of the present disclosure provides an all in one and direct means of shopping, and social media interaction for a brand.

The digital mall platform can bring name brand companies together onto a single ecommerce platform providing social media networking. The embodiments of the present disclosure can provide a mechanism for a digital platform having a similar effect as a brick and mortar mall concept, but in a digital electronic platform.

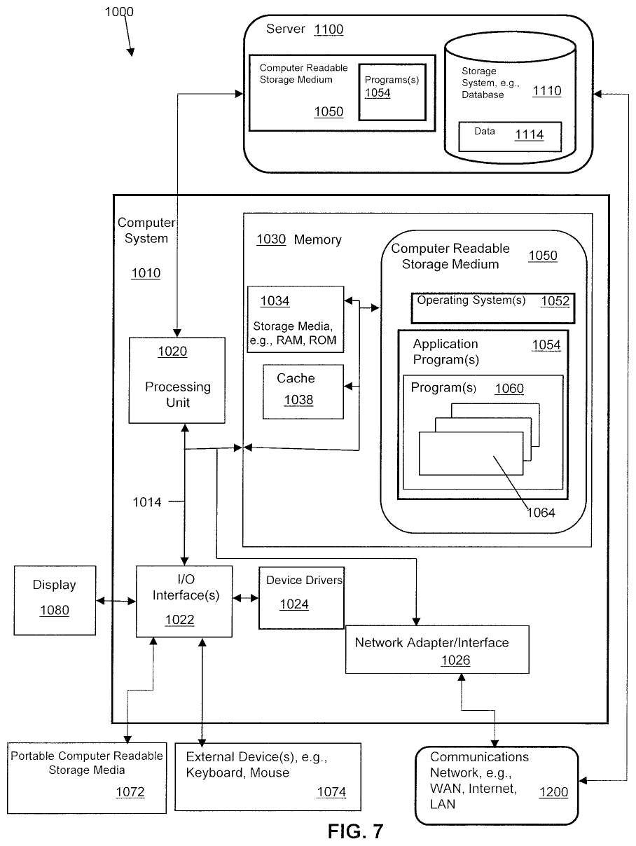

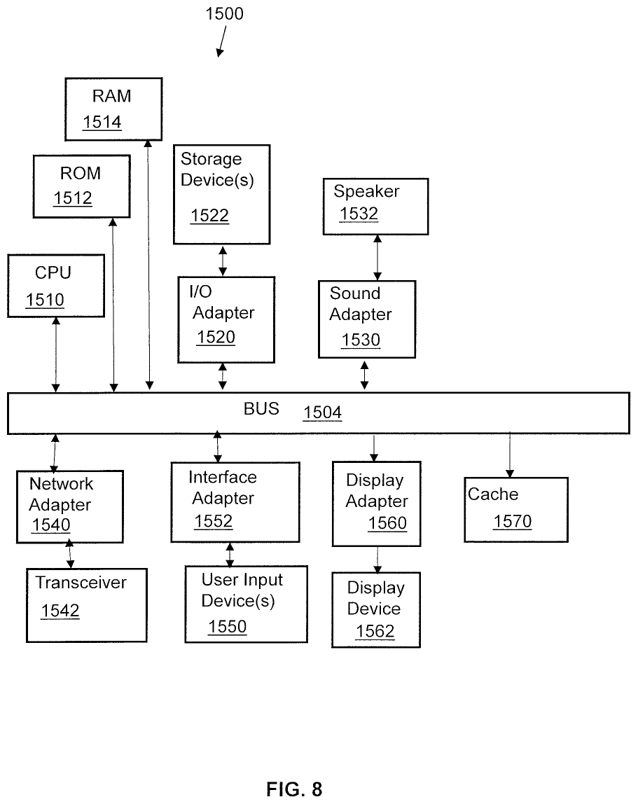

The computer system in the system 10 and discussed herein, such as a device computer 30, or a computer system 40, or a remote server can include all or part of a computer system 1000 and computer 1010 shown in FIG. 7, which discloses a generic computer system 1000 and computer 1010. It is understood that the above disclosed computers/computer systems and the computer 1010 are representative or illustrative of many alternative computer devices and are presented here as generic representations for the purposes of the embodiments of the present invention. In the embodiment discussed above, for illustrative purposes, the method of the present disclosure can be embodied in a computer program(s) 1060 (FIG. 7) or a software application stored on the computer 1010. The computer 1010 can all or in part represent the server 60. The server 62, in FIG. 1, is shown as a remote server to the device computer 30 and the computer system 70 and which can embody a program incorporating the method of the present disclosure, however, in other embodiment in accordance with the present disclosure, a computer program embodying the present method can be part of a computer system running locally in one or more of the illustrated components of the system 10 shown in FIG. 1 (as was discussed hereinabove). Further, a computer program embodying the present method can be cloud based or part of a cloud environment. In one embodiment such a cloud based system or environment can include all or part of the computer system 1000 (FIG. 7) and cloud based environment components shown in FIGS. 8 and 9. Alternative embodiments can include a computer program stored remotely (for example, on a remote server 1100 (FIG. 7)), and, for example, can be implemented as a service.

Referring to FIG. 7, a system or computer environment 1000 includes a computer system 1010 shown in the form of a generic computing device. The method 100, for example, may be embodied in a program 1060 embodied on a computer readable storage device, for example, generally referred to as memory 1030 and more specifically, computer readable storage medium 1050. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 shown in FIG. 5 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 7 as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 7, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method 100 (FIG. 2), for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to FIG. 8, an example system 1500 for use with and implementation of the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid-state magnetic device, and so forth. The storage device 1522 can be the same type of storage device or different types of storage devices. A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

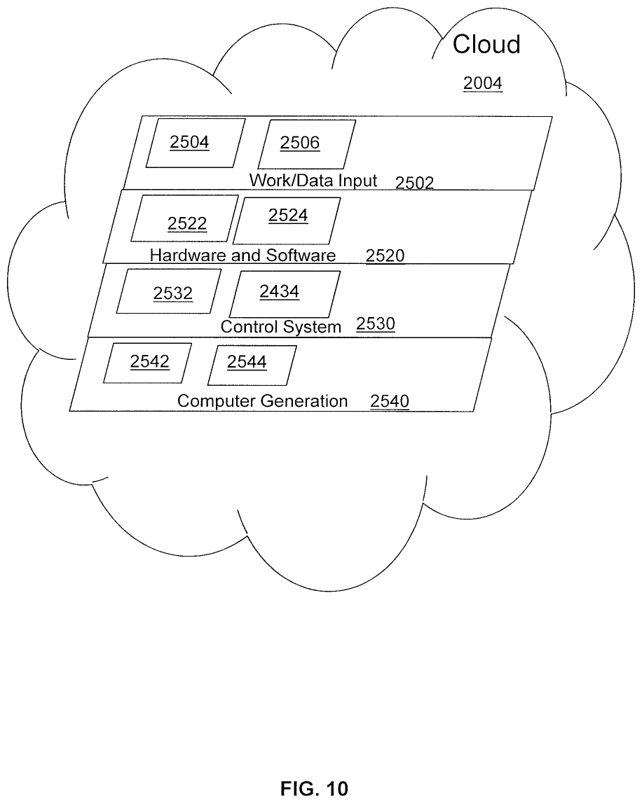

Referring to FIGS. 9 and 10, illustrative cloud computing environments are depicted. As shown, cloud computing environments can include one or more cloud computing nodes with which local computing devices used by cloud consumers interacting with the cloud via their devices. Such interactions and devices can include, for example, a personal digital assistant (PDA), a cellular telephone, desktop computer, laptop computer, and/or a computer system in an automobile or other such embedded computer system.

It is understood that although this disclosure includes a description on cloud computing, implementations of such descriptions are not limited to a cloud computing environment. Rather, embodiments of the present disclosure are capable of being implemented in conjunction with other types of computing environments. In one description, cloud computing is a model of service delivery for enabling convenient, on-demand network access to a shared pool of configurable computing resources (e.g., networks, network bandwidth, servers, processing, memory, storage, applications, virtual machines, and services). The resources can be rapidly provisioned and released with minimal management effort or interaction with a provider of the service. A cloud model may include, for example, characteristics, service models, and deployment models.

A cloud computing environment can include an infrastructure that includes a network of interconnected nodes. Illustrative cloud computing environments as depicted, for example, in FIGS. 9 and 10, are illustrative and not intended to limit a cloud computing environment that can be used operationally with the present disclosure. Types of computing devices shown are intended to be illustrative only and computing nodes and cloud computing environments can communicate with any type of computerized device over any type of network and/or network addressable connection (e.g., using a web browser).

Referring now to FIG. 9, an illustrative cloud computing environment 2000 is depicted. Cloud computing environment 2000 includes cloud 2004 (also referred to as computing cloud 2004), one or more cloud computing nodes 2010 (also referred to as virtualized computing nodes) which can cooperate with local computing devices used by cloud consumers, such as, for example, a personal digital assistant (PDA), a cellular telephone, a mobile device 2040, a desktop computer 2030, a laptop computer 2050, servers 2060, and other devices with a computer 2070, such as an automobile computer systems may communicate, or other consumer products or devices with such capabilities. The nodes 2010 may communicate with one another. The nodes may be grouped physically or virtually, in one or more networks, such as Private, Community, Public, or Hybrid clouds, or a combination thereof. This allows cloud computing environment 2000 to offer infrastructure, platforms and/or software as services for which a cloud consumer does not need to maintain resources on a local computing device. It is understood that the types of computing devices shown in FIG. 9 are intended to be illustrative only and that computing nodes 2010 and cloud computing environment 2000 can communicate with any type of computerized device over any type of network and/or network addressable connection (e.g., using a web browser).

The computing cloud 2010, one embodiment, can be envisioned as including a platform 2020, which includes applications 2024, and infrastructure 2028. The platform can include databases and data storage of all kinds, and provides the environment for infrastructure and applications. The applications can include all kinds of applications for performing functions, such as, for example, content data, monitoring functions, purchasing functions, chat and communication functions. The infrastructure can include, for example, servers, routers, switches, storage, and network infrastructure.

Referring now to FIG. 10, a set of functional layers can be provided by the cloud 2004 of the cloud computing environment 2000 (FIG. 9). It is understood that the components, layers, and functions shown in FIG. 10 are intended to be illustrative only and embodiments of the invention are not limited thereto. Work/Data Input layer 2502 provides examples of functionality for which the cloud computing environment may be utilized. Workloads and functions may be provided from this layer, for example, mapping and navigation 2504, software development and lifecycle management 2506, virtual classroom education delivery, data analytics processing; transaction processing; and providing a digital platform providing commercial and social media and products which are accessible by a user using a device (not shown).

Hardware and software layer 2520 includes hardware and software components. Examples of hardware components include: mainframes 2522; RISC (Reduced Instruction Set Computer) architecture based servers (not shown); servers 2524; blade servers; storage devices; and networks and networking components (not shown). In some embodiments, software components include network application server software, and database software (not shown).

In one example, a control system layer 2530 may provide functions such as resource provisioning 2532 and provide dynamic procurement of computing resources and other resources that are utilized to perform tasks within the cloud computing environment. The control system layer can provide metering and pricing 2434 and provide cost tracking as resources are utilized within the cloud computing environment, and billing or invoicing for consumption of these resources (not shown). In one example, these resources may include application software licenses. Security provides identity verification for cloud consumers and tasks, as well as protection for data and other resources. A user portal can provide access to the cloud computing environment for consumers and system administrators.

Computer generation layer 2540 can provide cloud computing resource allocation and management such that required service levels are met. Service Level Agreements can provide procurement of cloud computing resources for which a future requirement is anticipated. The Computer Generation layer 2540 provides an abstraction layer from which virtual entities may be provided, for example, virtual servers 2542; virtual storage 2544; virtual networks, including virtual private networks; virtual applications and operating systems; and virtual clients (not shown).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a digital platform hosted on a computer, the digital platform providing commercial products and social media interaction accessible by a user using a device, comprising:
receiving, using a computer system, a plurality of advertisements for posting on a digital platform;
receiving content data, using the computer system, for each of the plurality of advertisements;
posting, using the computer system, the plurality of advertisements on the digital platform, the digital platform being viewable on a display of a device, each of the advertisements having a section of the viewable area in a contiguous relationship to each other in the viewable area on the display of the device, the digital platform being hosted on the device using an application on the device and being in communication, using a communications network, with a content server which hosts the content data for each of the plurality of advertisements, the digital platform being accessible by a plurality of users via the application on computer devices, respectively, for each of the plurality of users;
configuring and enabling each advertisement as a portal within the digital platform for each of the respective advertisements, the advertisements being selectable and linking to the content data for a respective advertisement as a portal, respectively, when the advertisement is selected by one of the plurality of users on their device, the content data being hosted on the computer system of the digital platform;
accessing a first portal, in response to receiving a selection of a first advertisement by a user, the first portal being respective to the first advertisement selected by the user, the first portal being associated with first content data, for the first advertisement, stored on the computer system of the digital platform; and
displaying the first content data for the first advertisement selected within the first portal, respective to the advertisement, on the digital platform.

2. The method of claim 1, wherein the content data includes product information related to each of the advertisements.

3. The method of claim 1, wherein the content data includes payment options for buying products within a portal for an advertisement.

4. The method of claim 1, further comprising:
an interactive element which includes multiple options, selectable by the user, the multiple options include a link to opening a page related to the advertisement which the interactive element is associated, in response to the user selecting an option.

5. The method of claim 1, further comprising:
featured options which include a first featured option which links to a page of featured content, in response to the user selecting the first featured option, and wherein a second featured option links to a page for purchasing a product, in response to the user selecting the second featured option.

6. The method of claim 1, further comprising:
featured options which include a social network chat box, the social network chat box receives text from the user and provides communication with other users about products advertised.

7. The method of claim 1, further comprising:
featured options including a plurality of specified links or tabs, and each of the specified links or tabs link, respectively, to one or more of: a newsfeed, a worldfeed, a chat or chat room, or a profile.

8. The method of claim 1, wherein the viewable area is a defined area consisting of the sections of the viewable area wherein each of the sections have respective advertisements.

9. The method of claim 8, wherein the advertisements are in a grid formation in the viewable area.

10. The method of claim 1, further comprising:
in response to a user selecting an interactive element, opening a dialog box for the user to interact with the advertisement, the dialog box allowing the user to interact with other users.

11. A method for providing a digital platform hosted on a computer, the digital platform providing commercial products and social media interaction accessible by a user using a device, comprising:
opening a first advertisement, in response to receiving a selection by a user, using an application, of the first advertisement depicted on a display of a device, the first advertisement being in a first section of a viewable area of the display of the device, the viewable area having a plurality of advertisements each having a section of the viewable area in a contiguous relationship to each other in the viewable area on the display of the device, the opening of the first advertisement being opened as a first portal within a digital platform for the plurality of advertisements, and each of the advertisements accessing content data for each of the advertisements within the digital platform, the content data being hosted on a content server of the digital platform, and the application on the device communicating with the digital platform;
displaying a first plurality of interactive elements of the first advertisement, in response to the user selecting the first advertisement, the interactive elements being associated with the first advertisement, and the interactive elements being in the first portal within the digital platform as part of first content data for the first advertisement, and; and
displaying and providing featured options, as part of the first content data for the first advertisement for interaction related to the first advertisement, in response to the user selecting one or more of the first plurality of interactive elements, respectively.

12. The method of claim 11, wherein the content data includes product information related to each of the advertisements.

13. The method of claim 11, wherein the first content data includes payment options for buying products within the first portal for the first advertisement.

14. The method of claim 11, wherein the interactive element includes multiple options, selectable by the user, the multiple options include a link to opening a page related to the advertisement which the interactive element is associated, in response to the user selecting an option.

15. The method of claim 11, wherein the featured options, include a first featured option which links to a page of featured content, in response to the user selecting the first featured option, and wherein a second featured option links to a page for purchasing a product, in response to the user selecting the second featured option.

16. The method of claim 11, wherein the featured options include a social network chat box, the social network chat box receives text from the user and provides communication with other users about products advertised by accepting text from the other users.

17. The method of claim 11, wherein the viewable area is a defined area consisting of the sections of the viewable area wherein each of the sections have respective advertisements.

18. The method of claim 11, wherein the advertisements are in a grid formation in the viewable area.

19. The method of claim 11, further comprising:
in response to a user selecting an interactive element, opening a dialog box for the user to interact with the advertisement, the dialog box allowing the user to interact with other users.

20. A system for providing a digital platform hosted on a computer, the digital platform providing commercial products and social media interaction accessible by a user using a device, the system comprising:
a computer system comprising: a computer processor, a computer-readable storage medium, and program instructions stored on the computer-readable storage medium being executable by the processor, to cause the computer system to perform a method, to:
receive, using a computer system, a plurality of advertisements for posting on a digital platform;
receive content data, using the computer system, for each of the plurality of advertisements;
post, using the computer system, the plurality of advertisements on the digital platform, the digital platform being viewable on a display of a device, each of the advertisements having a section of the viewable area in a contiguous relationship to each other in the viewable area on the display of the device, the digital platform being hosted on the device using an application on the device and being in communication, using a communications network, with a content server which hosts the content data for each of the plurality of advertisements, the digital platform being accessible by a plurality of users via the application on computer devices, respectively, for each of the plurality of users;
configure and enable each advertisement as a portal within the digital platform for each of the respective advertisements, the advertisements being selectable and linking to the content data for a respective advertisement as a portal, respectively, when the advertisement is selected by one of the plurality of users on their device, the content data being hosted on the computer system of the digital platform;
access a first portal, in response to receiving a selection of a first advertisement by a user, the first portal being respective to the first advertisement selected by the user, the first portal being associated with first content data, for the first advertisement, stored on the computer system of the digital platform; and
display the first content data for the first advertisement selected within the first portal, respective to the advertisement, on the digital platform.
